(19) United States
(12) Patent Application Publication
(10) Pub. No.: US 2006/0039446 A1
(43) Pub. Date: Feb. 23, 2006

(54) Fast response clinical thermometer

(76) Inventor: Yung-Ku Lee, Taichung (TW)

Correspondence Address: Yung-Ku Lee, 235 Chung - Ho, Box 8-24, Taipei, TW

(21) Appl. No.: 10/923,757

(22) Filed: Aug. 23, 2004

(51) Int. Cl. G01K 7/00; G01K 1/00

(52) U.S. Cl. 374/208; 374/163

(57) ABSTRACT

A fast response clinical thermometer comprises a meter body; a probe rod extending from a front end of the meter body; a heat conductive head at a front end of the probe rod; a sensor being adhered to an inner wall of the heat conductive head; the sensor being connected to the control element of the meter body through a sensing wire for transferring measured temperature value to the control element; and a non-heat conductive unit filled into the heat conductive head for fixing the sensor and the sensing wire to the inner wall of the heat conductive head. The non-heat conductive unit is foam material or styrofoam. The meter body has a display and a control button. A control element is installed in the meter body. The control button serves for switching, calibration and actuation; and the display serves for displaying the measured result.

### FIELD OF THE INVENTION

The present invention relates to clinical thermometers, and particular to a fast response clinical thermometer with low heat capacity.

### BACKGROUND OF THE INVENTION

With reference to FIG. 1, a prior art clinical thermometer is illustrated. Generally, the electronic clinical thermometer has a sensor placed in the interior of a metal head and a conductive wire serves to connect the sensor to a circuit. Heat conductive rubber is filled in the metal head. When heat is absorbed by the metal head, the heat conductive rubber will transfer heat to the sensor. Then the conductive wire transfers temperature signals to the circuit. Then temperature value is displayed on a display.

The defect of above-mentioned prior art is that when heat is transferred from the metal head to the sensor, heat is dispersed to other portion of the clinical thermometer. Thereby, the heat conductive rubber will increase the heat capacity of the metal head so that the temperature increment of the sensor is slowed and thus the heat equilibrium is achieved slowly. As a result one or several minutes are necessary for tmeasuring the body temperature by the prior art clinical thermometer.

In one improvement disclosed in U.S. Pat. No. 6,419,388, the measured sensing element is glued to an inner wall of the metal head of a measuring end. A conductive wire is connected to a circuit. The defect of this structure is that heat absorbed from the metal head will disperse due to the convection of airflow in the metal head. The conductive wire is not helpful to the speed of heat equilibrium. Moreover, in the invention, the conductive wire is slender so as to reduce the heat capacity so as to reduce heat equilibrium time. However, to match with the slender conductive wire, the sensor is made of expensive 503FT-3P instead of 503ET. As a result, the cost is increased.

In one improvement structure, a sensor is installed at a metal head. A conductive wire winds around or is glued to the metal head so as to connect the sensor to a circuit. As a result, the head absorption area is increased so that the heat equilibrium can be achieved quickly.

For above mentioned structure, the defect is that the assembly work is complicated and tedious since it is necessary to wind the slender conductive wire around the small metal head so that the yield ratio is decreased. Moreover, although to wind conductive wire around the metal head can increase the heat absorption area, the heat capacity is also increased. As a result they generate counter effects so that the effect of increasing heat measuring speed is cancelled.

### SUMMARY OF THE INVENTION

Accordingly, the primary object of the present invention is to provide a fast response clinical thermometer which comprises a meter body; a probe rod extending from a front end of the meter body; a heat conductive head at a front end of the probe rod; a sensor being adhered to an inner wall of the heat conductive head; the sensor being connected to the control element of the meter body through a sensing wire; for transferring measured temperature value to the control element; and a non-heat conductive unit filled into the heat conductive head for fixing the sensor and the sensing wire to the inner wall of the heat conductive head. The non-heat conductive unit is foam material of styrofoam. The meter body has a display, and a control button, and a control element is installed in the meter body; the control button serves for switching, calibration and actuation; and the display serves for displaying the measured result.

The various objects and advantages of the present invention will be more readily understood from the following detailed description when read in conjunction with the appended drawing.

### BRIEF DESCRIPTION OF THE DRAWINGS

FIG. 1 is a perspective view of the fast response clinical thermometer of the present invention.

FIG. 2 is a partial schematic view of the fast response clinical thermometer of the present invention.

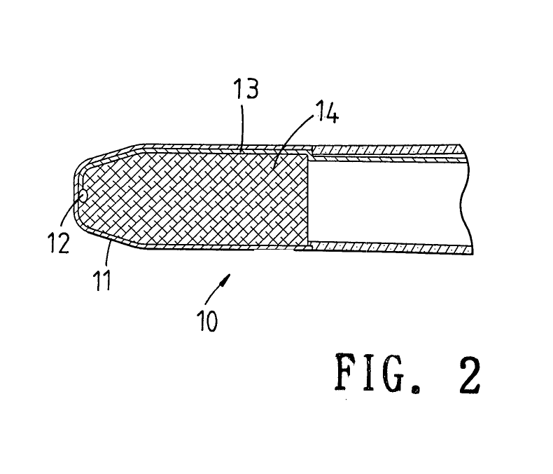

FIG. 3 is a partial cross section view of a prior art clinical thermometer.

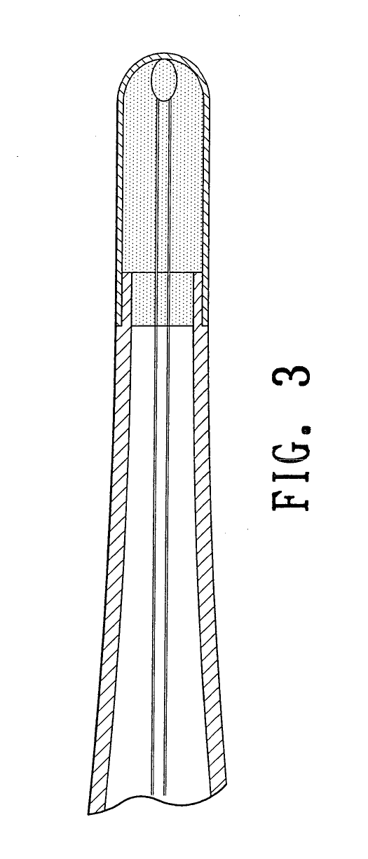

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

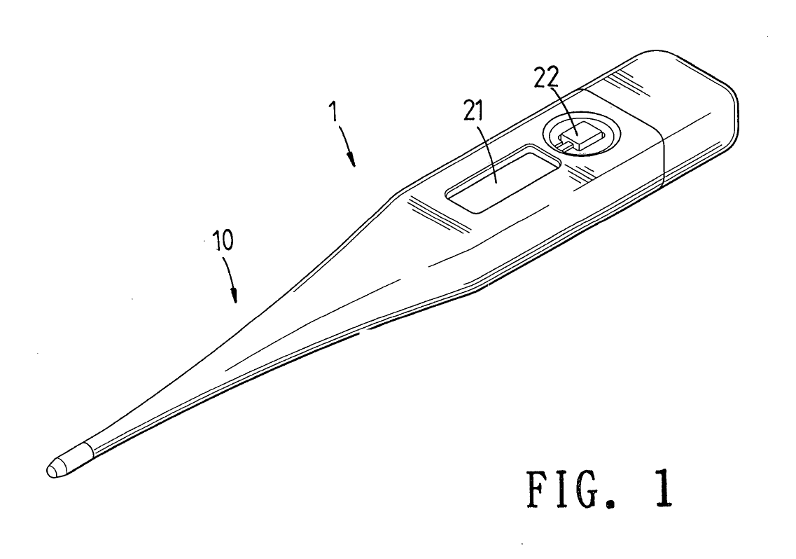

With reference to FIG. 1, the fast response clinical thermometer of the present invention is illustrated. The fast response clinical thermometer includes the following elements.

A meter body 1 has a display 21 and a control button 22. A control element (not shown) is installed in the meter body 1. The control button 22 serves for switching, calibration and actuation. The display 21 serves for displaying the measured result.

A probe rod 10 extends from a front end of the meter body 1.

A heat conductive head 11 is at a front end of the probe rod 10. A sensor 12 is adhered to an inner wall of the heat conductive head 11. The sensor 12 is connected to the control element of the meter body 1 through a sensing wire 13. Thereby, the sensing temperature of the sensor 12 can be transferred to the control element. A non-heat conductive unit 14 is filled into the heat conductive head 11 for fixing the sensor 12 and the sensing wire 13 to the inner wall of the heat conductive head 11. The non-heat conductive unit 14 is one of foam material or styrofoam.

In use of the present invention, the probe rod 10 of the meter body 1 is clamped in a portion of the user to be measured. Since the body temperature of the user is higher than that of the probe rod 10. Heat will transfer to the probe rod 10. Since the heat conductive head 11 is at the front end of the probe rod 10, the heat conductive head 11 has a fast heat conductive speed. The temperature of the sensor 12 in the heat conductive head 11 will increase gradually. Meanwhile, the sensing wire 13 adhered on the heat conductive head 11 will absorb heat from the heat conductive head 11. Not only the temperature difference between the sensor 12 and the sensing wire 13 is reduced, but also the heat equilibrium between the sensor 12 and the sensing wire 13 can be achieved fastly so as to reduce the time period in the measurement of the body temperature. Furthermore, the non-heat conductive unit 14 in the heat conductive head 11 will reduce the heat capacity of the heat conductive head 11 so as to prevent heat from leakage. Thereby, the body temperature can be measured rapidly.

In the present invention, by the sensor 12, sensing wire 13, the body temperature of the user can be measured rapidly. The correct body temperature is calculated by the control element. The display 21 serves to display the temperature value.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fast response clinical thermometer comprising:
a meter body;
a probe rod extending from a front end of the meter body;
a heat conductive head at a front end of the probe rod; a sensor being adhered to an inner wall of the heat conductive head; the sensor being connected to the meter body through a sensing wire for transferring measured temperature values; and
a non-heat conductive unit filled into the heat conductive head for fixing the sensor and the sensing wire to the inner wall of the heat conductive head.

2. The fast response clinical thermometer as claimed in claim 1, wherein the non-heat conductive unit is foam material.

3. The fast response clinical thermometer as claimed in claim 1, wherein the non-heat conductive unit is styrofoam.

4. The fast response clinical thermometer as claimed in claim 1, wherein the meter body has a display, and a control button; the control button serves for switching, calibration and actuation; and the display serves for displaying the measured result.

5. The fast response clinical thermometer as claimed in claim 1, wherein a control element is installed in the meter body, and the sensor is connected to the control element through the conductive wire.
